(19) United States
(12) Patent Application Publication
(10) Pub. No.: US 2006/0214316 A1
(43) Pub. Date: Sep. 28, 2006

(54) Apparatus for creating vortex rings in a fluid medium

(76) Inventor: David E. Whiteis, Germantown, MD (US)

Correspondence Address: LIEBERMAN & BRANDSDORFER, LLC, 802 STILL CREEK LANE, GAITHERSBURG, MD, 20878, US

(21) Appl. No.: 11/085,991

(22) Filed: Mar. 22, 2005

(51) Int. Cl. B01F 3/04

(52) U.S. Cl. 261/64.3; 261/79.2; 261/121.1

(57) ABSTRACT

The invention is a method and apparatus for generating vortex rings in a fluid medium. The apparatus is immersed in a body of water and includes first and second bodies. Gas is fed into a concave surface of the first body via a conduit from a finite or infinite supply source. As gas is supplied to the concave surface a single unitary bubble is formed therein. When the volume of the gas in the concave surface has attained the volume of the concave surface, the unitary bubble travels as a single unit to an exit aperture. A vacuum is formed between the two bodies when the unitary bubble enters the exit aperture. This vacuum functions to pull the entire unitary bubble through the aperture. Following departure from the exit aperture, a toroidal shaped bubble is formed.

### BACKGROUND OF THE INVENTION

1. Technical Field

This invention relates to a method and apparatus for producing vortex rings of gas in a fluid medium. More specifically, the apparatus may operate automatically with a finite supply of a gas, or it may be connected to a supply of gas such that the vortex rings are generated automatically and continuously.

2. Description of the Prior Art

Vortex rings are aesthetically pleasing with behaviors and aspects that are very interesting to many people. A smoke ring, which is a form of a vortex ring made from a visible form of gas, can be made to traverse a small room, and even extinguish a candle flame several feet away from where the smoke ring was generated. However, vortex rings are not limited to smoke rings. A vortex ring of identical size to a smoke ring may be made of air instead of smoke. Such a ring comprises similar characteristics to a smoke ring, and can also travel invisibly across the same room and extinguish a candle flame. Vortex rings have been studied by students in the field of fluid dynamics, which is an important part of airplane design and other engineering disciplines.

Most people have only seen a vortex ring in the form of a smoke ring. However, there is another form of a vortex ring that can be studied and enjoyed without involving the many known dangers and drawbacks associated with the creation of smoke rings. This alternative form of a vortex ring is a ring made of a gas and travels through a liquid medium, usually in an upward vertical direction. When created out of air within a medium of water, these vortex rings have also been known as bubble rings. They are enjoyable to play with and to study, although before this invention they have not been easy for the average person to generate.

Dolphins have been known to generate bubble ring type vortex rings, possibly for the entertainment and enjoyment of the exercise. However, these vortex rings are not readily available for viewing by humans, and dolphins have only rarely been captured on film creating bubble rings. The turbulence which appears in the wake of a jet plane, and which is dangerous to small planes that travel too close, will sometimes be in the form of ordinary vortex turbulence, which is similar to vortex rings. Vortex turbulence from planes is ordinarily invisible, so it can be challenging for engineers and especially engineering students to visualize how this effect occurs. Accordingly, there are several reasons why it is desirable to have a way to create vortex rings in a form that can be easily observed, studied, learned from and enjoyed.

There are several recent U.S. Patents which disclose different mechanical apparatus to aid in the production of vortex rings. In general, each of these patents relate to the generation of vortex rings in a fluid environment, such as water, with the use of air as the gas. For example, U.S. Pat. No. 5,947,784 to Cullen teaches an apparatus for use by a human being in a fluid immersed environment. The apparatus comprises an elbow shaped tool with an elongated horizontal portion, and an elbow leading to a short vertical portion. At the end of the vertical portion, the apparatus includes a valve assembly. The elongated portion of the apparatus allows air to exit the apparatus away from the user's face and hands, so that the air and water near the short vertical portion is not exposed to any turbulence or obstacles. The configuration of the valve body that closes when the user stops blowing air through the elongated portion causes the bubble of air that is released to be one large bubble of air, and helps produce the toroidal configuration of the vortex rings. In general, the valve assembly responds to short bursts of air through an elongated passageway to produce vortex rings. Alternatively, the elongated section of the apparatus may be connected to a source of gas under pressure. The introduction of a burst of gas under pressure causes the body of the valve to momentarily be unseated thereby allowing a burst of gas to escape and produce the toroidal shaped vortex ring. Accordingly, the Cullen patent requires a person to be immersed under water or for a gas under pressure to deliver short bursts of air to momentarily unseat the valve and produce a vortex ring.

U.S. Pat. No. 4,534,914 to Takahashi et al. teaches an apparatus for producing vortex rings. The apparatus uses an accumulator in the form of a cylindrical cup, wherein gas enters the accumulator and exits through an outlet affixed with a nozzle. When the accumulator is in a non-operating position, the valve member is urged by a coil spring toward the gas outlet, causing a seal of the outlet. However, in order to produce the vortex rings, a gas under pressure is introduced to the accumulator thereby causing an increase in the pressure in the interior chamber of the accumulator. The pressure of the gas causes the diaphragm to be outwardly inflated against surrounding water pressure and the force of the spring, which altogether takes the valve member out of contact with the gas outlet and discharges a pocket of gas through an exit nozzle. The gas stored in the accumulator is discharged into the nozzle which is closed by water pressure so that the nozzle is quickly opened and then closed again. Accordingly, the Takahashi et al. patent requires gas under pressure to be supplied to a chamber, and based upon the pressure of the gas the valve is unseated resulting in the generation of a vortex ring.

U.S. Pat. No. 6,736,375 to Whiteis teaches an apparatus for producing vortex rings. The apparatus includes a base and a moveable lever. Gas is received in a pocket on one side of the lever through a gas inlet. When the pocket reaches capacity, the buoyancy of the gas tilts the lever and the gas is released from an associated exit nozzle. A pair of stops are provided to define vertical displacement limits of said lever. Although the Whiteis patent does not require gas to be delivered under pressure to produce the vortex rings, it does require vertical displacement of the lever that produces the vortex shaped ring.

Other designs besides this one and U.S. Pat. No. 6,736,375 to Whiteis all require pressurized air, either low pressure (Cullen) or higher pressure (Takahashi.) It is because this design uses a trickle of air at no pressure that it can be used with a finite air supply and operate automatically.

Accordingly, what is desired is an apparatus for generating vortex rings which eliminates the need for supplying gas under pressure, and eliminates the necessity of moving parts. By mitigating or eliminating any mechanical parts that require displacement, the complexity and associated breakdown of such parts is removed.

### SUMMARY OF THE INVENTION

In one aspect of the invention, an apparatus is provided to generate a vortex ring in a fluid medium. The apparatus includes two stationary and parallel bodies. The first body has a top surface and a bottom surface, with the bottom surface having a pocket formed extending to a first level and an entrance to an exit aperture formed at a second level. The exit aperture extends from the second level to the top surface of the first body. In addition, a gas inlet is provided in the first body to deliver gas to the pocket. Gas in the pocket forms into a cohesive unit prior to entry into the exit aperture to form the vortex ring.

In another aspect of the invention, a ring generator is provided. The generator includes a first stationary section defined by first and second exterior surfaces. The first exterior surface has an interior concave section that communicates with an aperture that extends between the exterior surfaces, and a conduit that extends from an exterior wall of the first section into the concave section. A toroidal shaped ring is formed after gas emerges from the aperture.

In a further aspect of the invention, a method is provided for generating a vortex ring in a fluid medium. Gas is delivered to a concave section formed in a first level of a bottom surface of a first stationary body. A first cohesive unit of gas is formed in the concave section and pulled to an exit aperture entrance when the volume of gas in the concave section exceeds capacity. A toroidal shaped bubble is formed from the first cohesive unit after it departs the exit aperture.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a perspective view of an apparatus for producing vortex rings according to the preferred embodiment of the invention, and is suggested for printing on the first page of the issued patent;

FIG. 2 is a side elevational view of the apparatus of FIG. 1 taken from the right side;

FIG. 3 is a side elevational view of an alternative embodiment of FIG. 1.

FIG. 4 is perspective view of an alternative embodiment of FIG. 1 in communication with a finite source of gas.

FIG. 5 is a side elevational view of the apparatus of FIG. 4 taken from the right side.

FIG. 6 is a perspective view of an alternative embodiment of FIG. 1 mounted in a sealed cylinder.

### DESCRIPTION OF THE PREFERRED EMBODIMENT

### Technical Background

A vortex ring is a cohesive ring of fluid or gas that is created in a fluid or gas medium and travels in a particular direction through that medium. The most well known forms of vortex rings are made of smoke generated by the burning of tobacco products. However, another common form of vortex rings are bubble rings that are created in water. One way to create a bubble ring is by releasing a pulse of air into water that is relatively free of turbulence. This most commonly well known method of creating bubble rings is referred to here as the common method, and can only produce bubble rings that travel upwards towards the surface of the water. These are known as standard bubble rings. Other bubble rings can travel horizontally through a fluid medium, but are not a subject of this invention.

There are other specific parameters which must be adhered to in order to produce a gas vortex ring within a body of water using this method. In general, to create a standard bubble ring, the pulse of air must be released into the water through an opening that points in an upward direction into the water. The opening may simply be an aperture within a flat surface that is horizontal with respect to the surface of the water, or it may be a nozzle. However, the opening should be round or comprise a similar shape. The pulse of air that is released through the aperture should originate from a relatively turbulence-free reservoir of air. Any turbulence that does exist within the supply of air as it is released through the aperture should be symmetrical to an axis traveling through the center of the aperture, and any turbulence added to the air by a valve that may be used to control the flow of air out of the apparatus should also be symmetrical to an axis traveling through the center of the aperture. Accordingly, the state of the air prior to exiting the nozzle is but one important factor.

The air that is released from the aperture should be in the form of a pulse that begins and ends suddenly. Furthermore, the air should be in the form of a unitary bubble prior to release, and not in the form of a trail or plurality of bubbles. The air should not be preceded by fluid, nor should the air be followed by fluid. Preceding or following fluid around the gas pulse introduces turbulence to the fluid area where the vortex ring should form thereby preventing the vortex ring from forming. In addition, the pocket of air, i.e. unitary bubble, prior to release through the aperture should be approximately five to twenty times the volume of an imaginary sphere, wherein the diameter of that sphere is the same diameter as the aperture through which the air is to be released. Alternative proportions of the size of the pocket of air in relation to the diameter of the aperture may be employed for generating vortex rings in a fluid environment.

The bubble ring will form after being released from the aperture. Like any stable vortex ring traveling through a liquid or gaseous medium, the volume of the air or gas in the ring rotates as it travels through the fluid medium. Gas adjacent to the outer edge of the ring moves in an upward direction at a slower pace than the ring's overall upward movement, and the gas adjacent to the inside of the ring moves upward faster than the ring's overall vertical movement. Accordingly, if an observer ignores the ring's overall upward movement through the water, a speck of dust that was in the air of the ring near the surface of the ring would appear to spin, appearing first adjacent to the external edge of the ring, then adjacent to the bottom of the ring, then adjacent to the inside edge of the ring, and then adjacent to the top of the ring, repeating the pattern accordingly. The spin of the air then imparts a similar spin to the water immediately around the bubble ring, which adds to the stability of the bubble ring.

A bubble ring's spin is caused by the ring's movement through the water, and by the fact that the outside edge of the ring has a greater surface area than the inside edge, and is therefore more greatly affected by the friction created as a gas moves through the water. The spin makes the ring a stable object that enables the bubble to maintain its shape while traveling vertically in the water. As the ring travels toward the surface of the water, the diameter of the ring gradually increases. In general a bubble ring will maintain its shape until it hits the surface of the water, or until the diameter of the ring grows too large, at which time it becomes unstable and breaks up into ordinary bubbles. Accordingly, the characteristics of the water and gas prior to release through a round or near round opening are critical characteristics for forming a vortex ring in a fluid medium.

### Technical Details

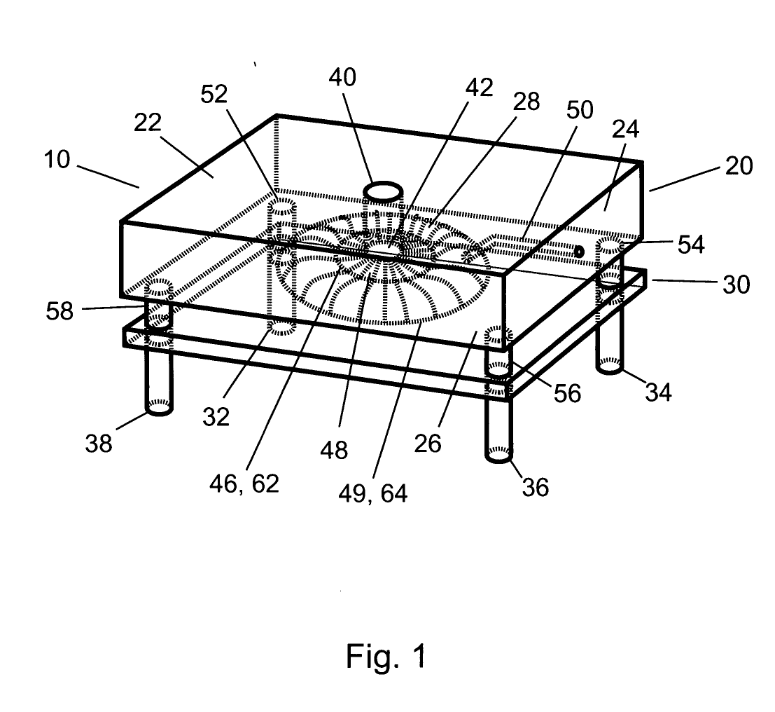

FIG. 1 is an illustration of a stationary apparatus for producing vortex rings in a fluid environment. Optimally, the apparatus is completely submerged in a tank and/or pool of water. The reference numeral 10 designates the apparatus. In a preferred embodiment, the apparatus is comprised of a material to provide the smooth edges and proper integrity to produce the vortex rings. The apparatus comprises a first body 20 attached or otherwise secured to a second body 30. The weight of the secured first and second bodies is sufficient to enable the apparatus 10 to rest on a bottom surface of a tank and/or pool. The first and second bodies 20 and 30, respectively, of the apparatus 10 are stationary. The first body includes an interior surface 26 and an exterior surface 22. The interior surface has a conduit 50 that extends from an exterior wall 24 to an interior concave surface 28, also known as a pocket. As shown, the first body has a rectangular shape, but the concave surface 28 is circular and located in the center of the rectangular shape. In a central portion of the first body, an exit aperture 40 is provided. The exit aperture 40 is concentric with the concave surface 28 and extends through the width of the first body 20 from an interior surface 26 to the exterior surface 22. A bridge 48 is provided to extend from an entrance 42 of the exit aperture 40 to an interior edge 46 of the concave surface 28. The bridge 48 is a flat unobstructed surface that includes a gradual slope from the interior edge 46 of the concave surface 28 to the entrance 42 of the exit aperture 40. The concave surface includes an exterior edge 49 that is concentric with both the interior edge 46 and the exit aperture 40. In one embodiment the shape and design of the bridge is smooth and unobstructed with a gradual slope to mitigate generating turbulence associated with delivery of gas from the concave surface 28 to the exit aperture 40.

The concave surface 28 and bridge 48 can have a smooth surface, but the device will successfully create bubble rings more often if the two surfaces 28 and 48 have a rough texture, or by creating the surfaces with a very fine pattern of lines or cross hatching. This type of surface is less sticky to the air that will become the bubble ring, so the air slips off the surface more readily once the air starts flowing out the exit aperture.

The concave surface 28 is designed to accommodate the gas and to move the gas toward the exit aperture 40. Both the interior concave surface 28 and the exit aperture 40 are located on different vertical levels of the interior surface. More specifically, the concave surface 28 is at a first vertical level 62 at the first interior edge 46, and the entrance to the exit aperture 40 is at a second vertical level 64. The first vertical level 62 is shallower, or farther from the top of the device, than the second vertical level 64. When the volume of gas in the concave surface 28 exceeds the volume of the concave surface 28, the gas flows to the entrance of the exit aperture 40. At the same time as the gas reaches the entrance of the exit aperture 40, a vacuum is formed between the first body 20 and the second body 30. It is this vacuum that pulls the gas from the concave surface 28 to the exit aperture 40 as a single cohesive unit of gas, i.e. a single bubble. A toroidal shaped bubble, i.e. a vortex ring, is generated subsequent to the cohesive unit of gas leaving a top surface of the exit aperture 40. Once the toroidal shaped bubble is formed, gas continues to enter the concave surface 28 through the conduit 50 if the gas supply is continuous or if gas remains from a finite source. Accordingly, a toroidal shaped ring is formed from a supply of gas to a stationary body.

The second body 30 is shown parallel, or near parallel, to the first body 20. The second body includes four legs 32, 34, 36, and 38 to lift the second body from a tank surface. Similarly, the first body 20 is shown with four legs 52, 54, 56, and 58 to hold the first body 20 in communication with the second body 30. In one embodiment, the length of each of the sets of legs may be vertically adjusted. For example, the legs 32, 34, 36, and 38 of the first body may be lengthened, shortened, or even removed, and the length of the legs 52, 54, 56, and 58 may be extended or shortened to vary the distance between the first and second bodies, 20 and 30, respectively. Decreasing the distance between the first and second bodies, 20 and 30, respectively, without changing other factors makes the toroidal shaped bubbles emerge from the exit aperture at a slower velocity. However, if the distance between the first and second bodies is too small, the gas will depart the exit aperture too slowly and a toroidal shaped bubble will not form. Similarly, if the distance between the two bodies 20 and 30, respectively, is increased beyond the optimal distance a toroidal shaped bubble will not form because some of the gas in the concave surface 28 will enter the exit aperture 40 as a non-unitary mass. In addition to the spacing of the two bodies 20 and 30, the manner in which gas is delivered to the concave surface 28 is critical. Gas supplied to the concave surface 28 must be delivered at a slow steady rate, whether from a finite source or a pump. In one embodiment, a valve or other mechanical apparatus may be employed to control the rate of delivery of the gas to the concave surface 28. Accordingly, both the manner in which gas is delivered to the concave surface 28 and the distance between the two bodies 20 and 30 must be properly set to support generation of toroidal shaped bubbles.

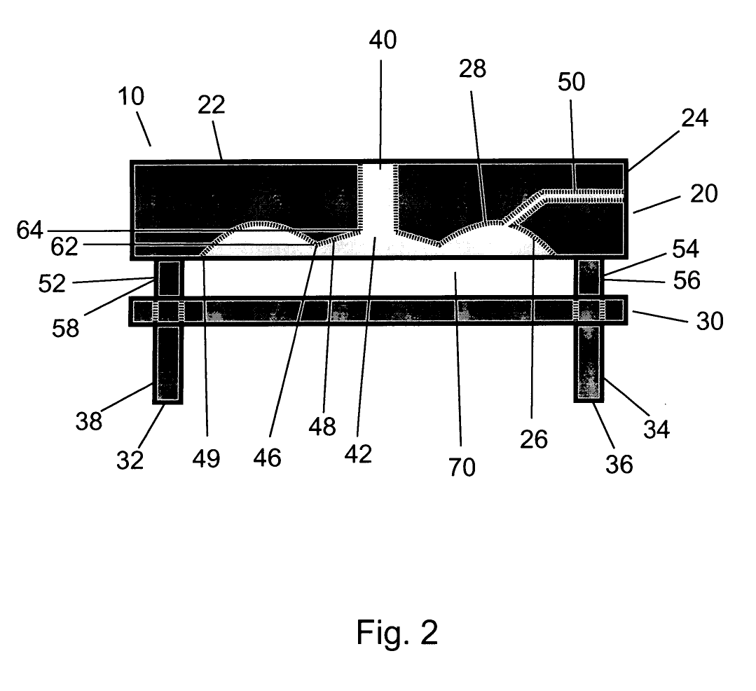

FIG. 2 shows the relationship between the first and second bodies, 20 and 30, respectively, and the gas pressure behavior as bubbles are forming and reforming. As the gas travels out of the exit aperture 40, a low pressure area is formed in the area 70 surrounding the concave surface 28. The low pressure area helps pull all air remaining out of the exit aperture 40. The second body 30 bounds the low pressure area 70. Accordingly, the low pressure 70 area formed between the first and second bodies contributes to the generation of a toroidal shaped bubble upon exit of the gas from the exit aperture.

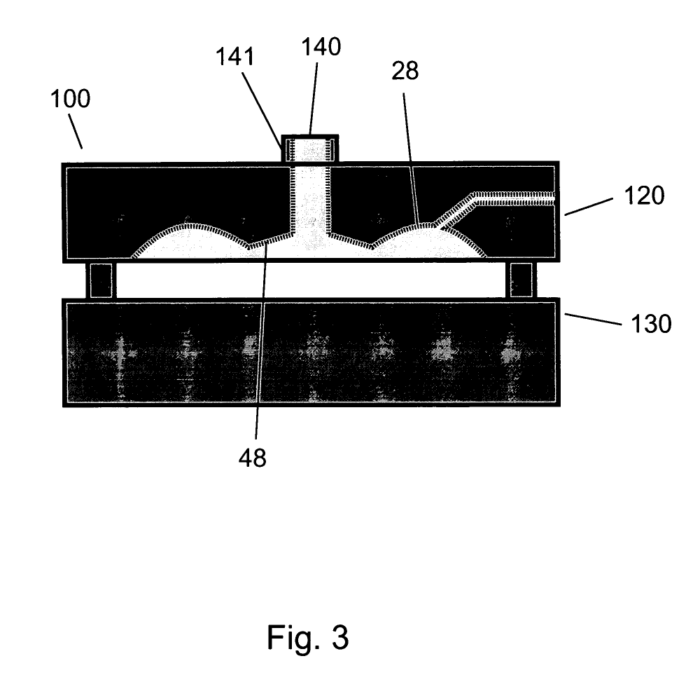

FIG. 3 is an illustration of the vortex ring generator 100 without legs extending from a second body 130. The distance between the first and second bodies, 120 and 130, respectively, shown here is fixed. In addition, the second body 130 has an increased height when compared to the height of the second body 30 shown in FIGS. 1 and 2, and a top surface of the exit aperture 140 includes an extension 141. The increased height of the second body 130 prevents gravel from entering the gap formed between the two bodies, and it also provides an increased weight for the second body 130. Since gas enters the apparatus during operation, the apparatus must have enough weight associated therewith to enable the apparatus to remain seated on a bottom surface of a tank or similar element. If the apparatus were to float during operation, it may become tilted and such a tilt would enable the gas to travel outside of the concave surface 28 in a direction away from the bridge 48. Furthermore, the exit aperture extension 141 is provided to increase the length of the exit aperture 140. The extension ensures that the entire length of the exit aperture 140 is optimal for the toroidal shaped bubble. A longer exit aperture 140 supports acceleration of gas there through at an increased velocity, which can help ensure a stronger initial spin to the formed bubble. However, if the length of the exit aperture is too long, the exiting bubble may be subject to an increase in turbulence in the initial moments of the formation, which would reduce chances of such a formation. Accordingly, the embodiment shown herein demonstrates the usefulness of increasing the height of the second body when extend legs are not provided, as well as an extender for the exit aperture if the length of the exit aperture is not sufficient to generate the toroidal shaped bubbles.

In one embodiment, the diameter of the exit aperture is 5 millimeters, the distance between the first body 20 and the second body 30 is approximately 10 millimeters, the diameter of the outer edge of the bridge 48 is 30 millimeters, the diameter of the outer edge of the concave surface 28 is 60 millimeters, the depth of the concave surface 28 is 3 millimeters, and the difference in depth between the inner and outer edges of the concave surface 28 is 1 millimeter.

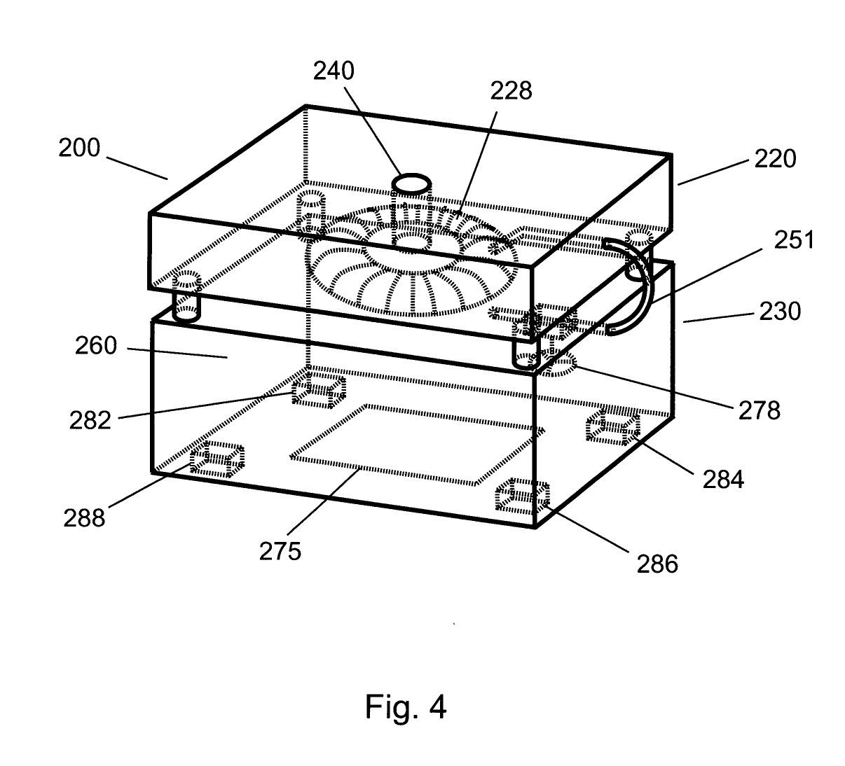

FIG. 4 is a perspective view of a third embodiment with air supplied from a finite source. It shows the ring generator apparatus 200 of FIG. 1 with an air supply 260 in an interior portion of the second body. The first body 220 is nearly identical to the first body 20 of FIG. 1 except the conduit 251 extends from a finite air supply to concave surface 228. The second body 230 houses a gas reservoir that supplies gas to the first body while maintaining the properties of the second body required for the formation of toroidal shaped bubbles. An adjustable valve 278 may be provided to communicate with the conduit 251 to ensure that the gas flows at a measured rate from the reservoir to the conduit. The rate of which the gas is delivered to the conduit will affect the frequency in which toroidal shaped bubbles are created. In addition, the reservoir may include a plurality of weights 282, 284, 286, and 288 to ensure that the second body will remain seated on a stationary surface. At such time as the gas in the second body 230 has been used up, the apparatus 200 may be lifted out of the body of water and the gas supply may be replenished. In one embodiment the second body 230 may include an opening 275 to enable water to drain out and air to replace it when the device is lifted out of the water for replenishment of the air supply.

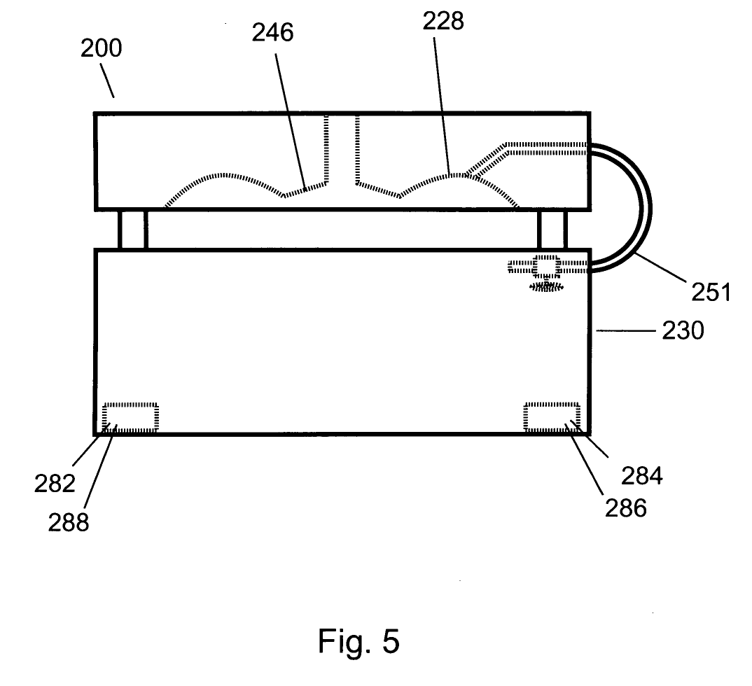

FIG. 5 is a side elevational view of the apparatus of FIG. 4. The gas conduit 251 is shown extending directly into the concave surface 228 at or near the highest point thereof. The position of the conduit 251 with respect to the geometry of the concave surface 228 ensures that as long as gas is supplied to the concave surface 228 free from water or water droplets, the gas bubble formed in the concave surface is a unitary formation of gas without water therein to disrupt the formation. As shown herein, the second body 230 includes a plurality of weights to hold the body 230 on a planar surface. Accordingly, the placement of the conduit directly into the highest or near highest portion of the concave surface contributes to the formation of a unitary bubble of gas to travel across the bridge 246.

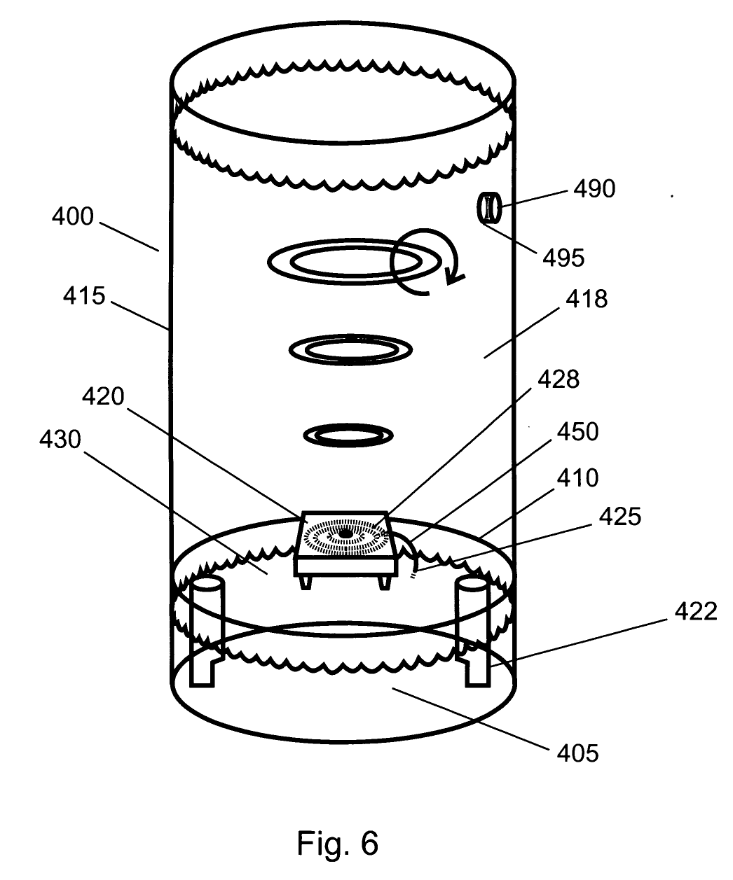

FIG. 6 is an embodiment showing a fourth embodiment of a ring generator 400. The first body 420 is mounted in a sealed cylinder 415 of water. The first body 420 rests on a horizontal wall 410 that separates a bottom portion 405 from the top portion 418 of the cylinder 415. The horizontal wall 410 functions as a wall separator as well as the second body 430. The bottom portion 405 of the ring generator 400 stores gas therein. A wall aperture 425 is provided in the horizontal wall 410. The conduit 450 extends from the bottom portion 405 to the concave surface 428 of the first body to supply gas stored in the bottom portion 405 to the first body 420. When all of the gas in the bottom portion 405 has expired, the sealed cylinder 415 may be tilted approximately 120 degrees off of the plane to enable gas to flow into a refill tube 422 of the bottom portion 405. When the cylinder 415 is returned to an upright position, the process of generating toroidal shaped bubbles may continue. In addition, a closing device 490 is provided on a sidewall aperture 495 of the cylinder 415. The closing device may be removed from the sidewall aperture 495 to enable the water to be drained from the cylinder 415. Similarly, water may be added to the cylinder 415 when the closing device is in a removed position. At such time as water is placed into the cylinder 415, the closing device 490 must be placed over or within the sidewall aperture 495 to prevent the water from exiting the top portion 418 of the cylinder 415.

### Advantages Over the Prior Art

The apparatus disclosed herein mitigates the complexities of both mechanical apparatus and human intervention in generating toroidal shaped bubbles. Operation of the apparatus of FIGS. 1-6 requires minimal skill on the part of the artisan. The user must simply connect the one end of the conduit to a source of gas. The gas is delivered to the conduit at a steady rate to ensure that toroidal shaped rings are generated at a steady frequency. In one embodiment, a valve or regulator may be employed to regulate the rate at which gas is delivered to the concave surface. The ring generator shown in each of the embodiments does not have any moving parts. Gas is delivered to the concave surface from a gas source, and at such time as the volume of the concave surface is filled with gas, the gas travels as a unitary bubble across the bridge to the entrance of the exit aperture. Upon release of the gas from the exit aperture, gas begins again to be delivered to the concave surface. Once the distance between the first and second bodies is calibrated, the apparatus will continue to generate vortex rings as long as the gas supply is provided. Following set-up and calibration of the apparatus, no human intervention is required. In addition, the apparatus does not require the gas to be a pressurized gas. One of the few restrictions of the apparatus is that it be in communication with a level surface. The horizontal position of the first and second bodies in combination with the elements of the first body supports generation of toroidal shaped bubbles while allowing both the first and second bodies to remain stationary.

In addition to the reduction of human error and or intervention, the apparatus of the preferred embodiment does not require any complex mechanical systems for the generation of vortex rings. As shown in the prior art, apparatus for generating vortex rings generally comprise a plurality of membranes, resilient members, complex valve mechanisms, and/or turbulent fluid. However, the apparatus disclosed and claimed herein does not support mechanical movement of the first or second bodies subsequent to calibration. The apparatus of the preferred embodiment has a conduit to deliver gas from a gas source to a concave surface. Subsequent to calibration, the only element that has mechanical movement is the gas from the gas source to the concave surface, and from the concave surface to the exit aperture. Accordingly, the apparatus disclosed herein mitigates error and need for replacement of mechanically resilient members.

This design has no hinge or other moving part to get algae and other foreign matter stuck in it, which would prevent it from operating. It is easy to clean, and has no fragile parts. For these reasons, it is safe around many different types of animals where other designs would not be safe or allowed. This design does not use electricity or pressurized air, which are required for other designs, and are prohibited from many environments where fish and other animals are kept.

### Alternative Embodiments

It will be appreciated that, although specific embodiments of the invention have been described herein for purposes of illustration, various modifications may be made without departing from the spirit and scope of the invention. In particular, the apparatus may be adapted for functioning with a finite source of gas or from an infinite source of gas. The gas also may be in the form of non-pressurized air. Regardless of the source, the inventions are simple mechanical apparatus designed to produce vortex rings with minimal human intervention and minimal components that may be subject to failure over an extended period of time. Accordingly, the scope of protection of this invention is limited only by the following claims and their equivalents.

I claim:

1. An apparatus to generate a vortex ring in a fluid medium comprising:
a first body having a top surface and a bottom surface;
said bottom surface of said first body having a pocket formed at a first level and an exit aperture entrance formed at a second level, said exit aperture adapted to extend from said second level to said top surface of said first body;
a gas inlet in said first body adapted to deliver gas to said pocket; and a second body parallel to said first body and spaced apart from said first body.

2. The apparatus of claim 1, wherein gas in said pocket is adapted to enter said exit aperture when a volume of gas in said pocket exceeds a volume of said pocket.

3. The apparatus of claim 2, further comprising a vacuum formed between said first and second bodies upon entry of gas into said exit aperture.

4. The apparatus of claim 3, wherein said vacuum is adapted to pull said gas from said pocket to said exit aperture as a first cohesive unit.

5. The apparatus of claim 1, further comprising said first cohesive unit of gas forming a toroidal shaped bubble after an exit from said exit aperture.

6. The apparatus of claim 1, further comprising a second cohesive unit of gas adapted to be formed in said pocket subsequent to said first cohesive unit of gas entering said exit aperture.

7. A ring generator comprising:
a first stationary section defined by first and second exterior surfaces;
said first exterior surface having an interior concave section in communication with an aperture, wherein said aperture is adapted to extend between said exterior surfaces;
a conduit adapted to extend from an exterior wall of said first section into said interior concave surface; and
a toroidal shaped ring adapted to be formed after emergence of gas from said aperture.

8. The ring generator of claim 7, further comprising a second stationary section spaced apart from said first stationary section.

9. The ring generator of claim 8, wherein distance between said first and second sections may be adjusted.

10. The ring generator of claim 7, further comprising said gas adapted to be delivered to said concave surface through said conduit.

11. The ring generator of claim 7, further comprising delivery of said gas to said aperture when a volume of gas in said interior concave section exceeds a volume of said concave section.

12. The ring generator of claim 11, wherein said gas is delivered from said concave section to said aperture as a first cohesive unit of gas.

13. A method for generating a vortex ring in a fluid medium comprising:
delivering gas to a concave section formed in a first level of a bottom surface of a stationary first body;
forming a first cohesive unit of gas in said concave section;
pulling said first cohesive unit of gas in said concave section to an exit aperture entrance upon a volume of gas in said concave section exceeding capacity; and
forming a toroidal shaped bubble from said first cohesive unit following a departure of said gas from said exit aperture.

14. The method of claim 13, further comprising forming a vacuum between said first body and a parallel second body during formation of said first cohesive unit of gas.

15. The method of claim 14, wherein said vacuum is adapted to increase proportionally with an increase of gas volume delivered to said concave section.

16. The method of claim 14, wherein said vacuum contributes to the step of pulling said first cohesive unit of gas in said concave section to said exit aperture.

17. The method of claim 13, further comprising forming a second cohesive unit of gas in said concave section following said first cohesive unit of gas entering said exit aperture.
